(19) United States
(12) Patent Application Publication
(10) Pub. No.: US 2005/0006970 A1
(43) Pub. Date: Jan. 13, 2005

(54) Electromotive drive, in particular for a pump for an electrohydraulic vehicle steering device

(75) Inventors: Hartmut Klingenberg, Radolfzell (DE); Frank Ott, Rielasingen (DE); Hardy Wilkendorf, Owingen (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW AUTOMOTIVE ELECTRONICS & COMPONENTS GMBH & CO. KG

(21) Appl. No.: 10/864,118

(22) Filed: Jun. 9, 2004

(30) Foreign Application Priority Data
Jun. 10, 2003 (DE) 103 26 074.9

(51) Int. Cl. H02K 7/10; H02K 5/16; H02K 5/00; H02K 7/08

(52) U.S. Cl. 310/91

(57) ABSTRACT

An electromotive drive, in particular for a pump for an electrohydraulic vehicle steering device, has a motor mounting, which has a cylindrical pin, and a stator having drive coils. The stator is penetrated by the cylindrical pin of the motor mounting and is held thereby. Between the inner wall of the stator and the outer wall of the cylindrical pin of the motor mounting a tolerance ring is arranged, a torque transmission taking place between stator and motor mounting via the tolerance ring.

The invention relates to an electromotive drive, in particular for a pump for an electrohydraulic vehicle steering device, with a motor mounting which has a cylindrical pin, and with a stator having drive coils, which is penetrated by the cylindrical pin of the motor mounting and is held thereby.

### BACKGROUND OF THE INVENTION

In electrohydraulic vehicle steering devices, generally electromotor-driven pumps are used, these drives being designed for a brief operation at full load. Known motors for electrohydraulic steering devices generate intrusive noises at full load operation, which are due substantially to high-frequency fluctuations of the torque occurring on the drive.

Electromotors of known electromotive drives or pumps have a stator and a rotor realized as an outside rotor, which surrounds the stator in a cup shape. The stator sits on a cylindrical pin which is formed from a motor mounting and by which it is penetrated. This cylindrical pin is frequently constructed as a hollow cylindrical bearing shaft. The bearing shaft serves for receiving and rotatably bearing of a drive shaft of the electromotive drive. The drive shaft is, in turn, connected with the rotor in a suitable manner. For protection, the drive is generally surrounded by a drive housing which is connected with the motor mounting.

Frequently, to transfer the torque from the stator to the motor mounting, which is constructed as a bearing shaft, an axial splint is inserted between stator and motor mounting in grooves, situated opposite each other, in the inner wall of the stator and the outer wall of the cylindrical pin of the motor mounting, or a spiral clamping pin is provided in the region. In addition, then, for axial security, a further holding element must be used. Through the use of an axial splint or a spiral clamping pin for torque transmission, owing to unavoidable tolerances in the component manufacture, a slightly eccentric bearing of the stator is brought about, which owing to vibrations of the stator/motor mounting system occurring in operation, leads to an intrusive increase to the running noises of the electromotive drive.

From the EP 1 135 841 B1 an electromotive drive is known which ensures an improved suppression of the instructive noises occurring in known drives, by a rigid coupling between the stator and a motor mounting constructed as bearing shaft being largely eliminated. The torque transmission takes place in this electromotive drive substantially by a coupling of the stator with the drive housing, the bearing shaft penetrating the stator serving to hold the stator only in the transverse plane to the axis of the bearing shaft. The actual torque transmission takes place by a connection of the stator with a carrier plate fastened in the housing. This carrier plate must be dimensioned accordingly to avoid a mechanical overload. Likewise, the connection which can be realized for example by means of the contact connections of the drive coils of the stator, must be constructed so as to be sufficiently durable and secure. Between the inner wall of the stator and the outer wall of the bearing shaft, a gap is provided, the gap preferably being at least partially filled with a viscous medium. In addition, the introduction of flexible elements such as O-rings into the gap is proposed. In this way, a reduced coupling of stator and bearing shaft is achieved, through which no substantial torque transmission is possible, which of course has a favourable effect on the noise development of the drive.

A force-fitting connection of the stator with a carrier plate, which in turn is securely connected with a drive housing, necessitates an additional structural expenditure and requires a secure dimensioning against mechanical overload. Furthermore, the filling of the gap between the inner wall of the stator and the outer wall of the bearing shaft with a viscous medium or an application of additional flexible vibration-damping elements to bridge the gap means increased manufacturing work and hence increased costs in manufacture. Furthermore, it has been found in practice that neither a desirable complete mechanical uncoupling of stator and bearing shaft nor an alternatively desirable complete mechanical coupling between stator and bearing shaft is able to be achieved, which has a negative effect on the noise development of the drive.

The invention is therefore based on the problem of providing an electromotive drive, in particular for a pump for an electrohydraulic vehicle steering device, in which an improved suppression of the intrusive noises occurring in operation in known drives is ensured by simple structural measures.

### SHORT DESCRIPTION OF THE INVENTION

This problem is solved according to the invention in that between the inner wall of the stator and the outer wall of the cylindrical pin of the motor mounting, a tolerance ring is arranged, a torque transmission taking place between stator and motor mounting by means of the tolerance ring. According to the invention, therefore, a torque transmission is realized between stator and motor mounting by means of a substantially rigid coupling. A play which may be present between the inner wall of the stator and the outer wall of the motor mounting, due to the manufacturing tolerances of the components, is balanced out by the tolerance ring and ensures a concentric bearing of the stator with respect to the cylindrical pin of the motor mounting. Such a concentric bearing of the stator leads to reduced intrusive noises during the load fluctuations which generally occur in the operation of the drive. Vibrations of the stator/motor mounting system are reduced. In addition, the band width of the transmitted noises is reduced. The stator is, moreover, secured by the tolerance ring against movement in axial direction along the cylindrical pin of the motor mounting. The use of an axial splint or of a spiral clamping pin is not necessary in accordance with the invention, whereby also the necessity of providing corresponding grooves on stator and motor mounting is eliminated. Likewise, no additional holding element is required for the axial securing of the stator. Costly structural measures are not necessary. Therefore, the electromotive drive according to the invention can as a whole be produced in a simplified manner and therefore also at a more favourable price.

Advantageous embodiments of the invention will be apparent from the sub-claims.

### BRIEF DESCRIPTION OF THE DRAWINGS

The invention is described in further detail below with the aid of embodiments which are illustrated in the enclosed drawings. In these:

FIG. 1 shows in an axial sectional view an electromotive drive according to the invention.

FIG. 2 shows diagrammatically in an axial sectional view the region of stator and cylindrical pin of a motor mounting of an electromotive drive according to the invention.

FIG. 3 shows in a perspective view a cylindrical pin of a motor mounting with tolerance ring of an electromotive drive according to the invention.

### DETAILED DESCRIPTION OF THE INVENTION

In the Figures, elements corresponding to each other respectively are given the same reference numbers.

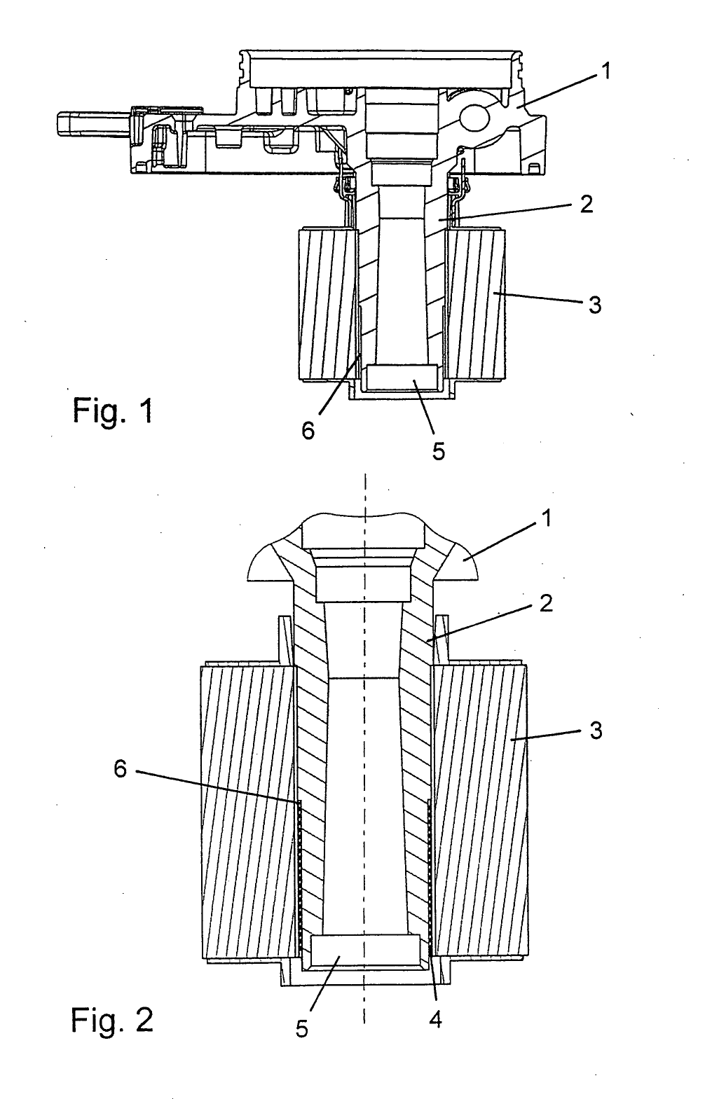

FIG. 1 shows an electromotive drive in an embodiment of the invention with a motor mounting 1, which has a cylindrical pin 2, and a stator 3 sitting on the cylindrical pin 2. The cylindrical pin 2 of the motor mounting 1 is constructed as a hollow cylindrical bearing shaft 5 for the rotatable mounting of a drive shaft of the drive. A rotor surrounding the stator 3 in a cup shape is not shown in the figure. The rotor is constructed as an outside rotor and is mounted rotatably inside the housing 1 by means of a drive shaft securely connected therewith in the bearing shaft 5. The entire arrangement is surrounded by a housing which is likewise not illustrated in the figure.

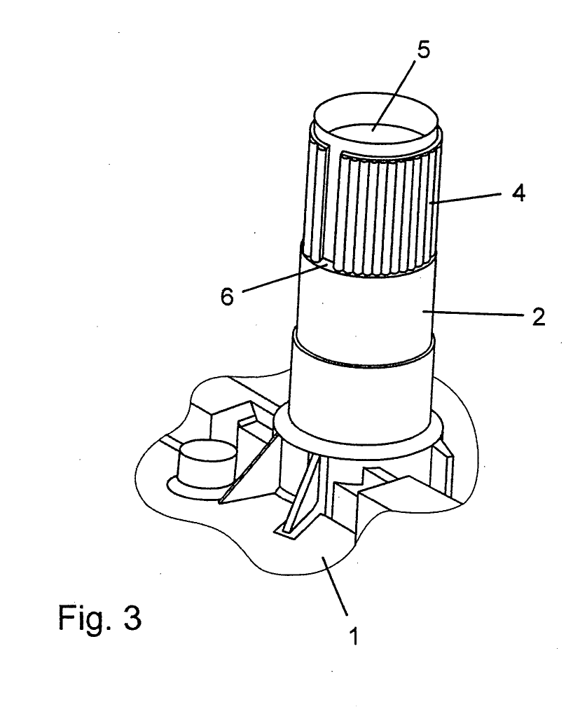

In order to avoid an intrusive noise development frequently occurring in practice in known drives, which is caused by high-frequency fluctuations of the generated torque and vibrations of the stator/motor mounting system connected therewith, in accordance with the invention the stator 3 is coupled in a force-fit with the motor mounting 1 by means of a tolerance ring 4. The tolerance ring 4, as shown in FIG. 2, is arranged in an axial recess 6 on the cylindrical pin 2 of the motor mounting 1.

In a preferred embodiment of the invention, the tolerance ring 4, constructed in a sleeve shape, has an undulating path along the periphery of its inner wall. It is inserted into the stator 3 before the installation of the stator 3 on the motor mounting 1 and fixes the stator 3 in a press fit after completed installation on the cylindrical pin 2. The undulations along the inner wall of the tolerance ring 4 rest here on the outer wall of the cylindrical pin 2 in the region of the axial recess 6. Carbon steel or stainless spring steel are used for example as material for the tolerance ring 4.

In a further embodiment of the invention, the tolerance ring 4, which is constructed in a sleeve shape, has an undulating path along the periphery of its outer wall, as shown in FIG. 3. Also in this way, on installation a press fit is achieved between stator 3 and motor mounting 1. The undulations along the outer wall of the tolerance ring 4 rest here on the inner wall of the stator 3.

A spiral clamping pin or axial splint, provided in known motors, for the force- and form-fitting coupling of stator 3 and motor mounting 1 is dispensed with in the construction according to the invention. Through the use according to the invention of a tolerance ring for torque transmission between stator 3 and motor mounting 1, a concentric mounting of the stator 3 results with respect to the cylindrical pin 2 of the motor mounting 1 in each operating state of the drive and over a wide temperature range of approximately −40 degrees C. to +120 degrees C. Intrusive noise-generating vibrations of the stator/motor mounting system are substantially reduced by this concentric mounting.

1. An electromotive drive, in particular for a pump for an electrohydraulic vehicle steering device, with a motor mounting which has a cylindrical pin, and with a stator having drive coils, said stator being penetrated by said cylindrical pin of said motor mounting and is held thereby, wherein between an inner wall of said stator and an outer wall of said cylindrical pin of said motor mounting a tolerance ring is arranged, a torque transmission taking place between said stator and said motor mounting by means of said tolerance ring.

2. The electromotive drive according to claim 1, characterized in that said stator is mounted concentrically with respect to said cylindrical pin of said motor mounting.

3. The electromotive drive according to claim 1, characterized in that said cylindrical pin of said motor mounting is constructed as a hollow cylindrical bearing shaft for rotatably mounting a drive shaft of said drive.

4. The electromotive drive according to claim 3, characterized in that said drive shaft is connected with a rotor constructed as an outside rotor.

5. The electromotive drive according to claim 1, characterized in that said stator is secured by said tolerance ring to said cylindrical pin of said motor mounting in axial direction.

6. The electromotive drive according to claim 1, characterized in that said tolerance ring is constructed in a sleeve shape with an undulating path over the periphery of an inner wall.

7. The electromotive drive according to claim 1, characterized in that said tolerance ring is constructed in a sleeve shape with an undulating path over the periphery of an outer wall.

8. The electromotive drive according to claim 1, characterized in that said cylindrical pin of said motor mounting has an axial recess to receive said tolerance ring.

9. The electromotive drive according to claim 1, characterized in that said tolerance ring consists of carbon steel.

10. The electromotive drive according to claim 1, characterized in that said tolerance ring consists of stainless spring steel.
